(19) United States
(12) Patent Application Publication
(10) Pub. No.: US 2026/0073495 A1
(43) Pub. Date: Mar. 12, 2026

(54) LOCAL TONE MAPPING WITH NOISE REDUCTION AND EDGE PRESERVATION FOR VIDEO SEE-THROUGH (VST) EXTENDED REALITY (XR)

(71) Applicant: Samsung Electronics Co., Ltd., Suwon-si (KR)

(72) Inventors: Yingen Xiong, Mountain View, CA (US); Christopher A. Peri, Mountain View, CA (US)

(21) Appl. No.: 19/063,059

(22) Filed: Feb. 25, 2025

Related U.S. Application Data
(60) Provisional application No. 63/691,763, filed on Sep. 6, 2024.

(51) Int. Cl. G06T 5/92; G06T 5/20; G06T 5/70; G06T 5/73; G06T 15/00; G06T 15/20; G06T 17/20

(52) U.S. Cl. CPC G06T 5/92; G06T 5/20; G06T 5/70; G06T 5/73; G06T 15/005; G06T 15/20; G06T 17/205; G06T 2207/10024; G06T 2207/20192; G06T 2207/20208; G06T 2210/32; G06T 2210/36

(57) ABSTRACT

A method includes obtaining first image frames having a first dynamic range captured using at least one imaging sensor of a VST XR device. The method also includes, for each of at least one of the first image frames, generating a tone mapping filter configured to provide noise reduction and edge preservation while being guided by image and feature information and applying the tone mapping filter to the first image frame in order to transform the first image frame into a second image frame having a second dynamic range smaller than the first dynamic range. The tone mapping filter is applied to a luminance channel and not chrominance channels associated with the first image frame. The method further includes presenting one or more rendered images or videos based on the second image frame for each of at least one of the first image frames using at least one display.

### CROSS-REFERENCE TO RELATED APPLICATION AND PRIORITY CLAIM

This application claims priority under 35 U.S.C. § 119(e) to U.S. Provisional Patent Application No. 63/691,763 filed on Sep. 6, 2024. This provisional patent application is hereby incorporated by reference in its entirety.

### TECHNICAL FIELD

This disclosure relates generally to extended reality (XR) systems and processes. More specifically, this disclosure relates to local tone mapping with noise reduction and edge preservation for video see-through (VST) XR.

### BACKGROUND

Extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes.

### SUMMARY

This disclosure relates to local tone mapping with noise reduction and edge preservation for video see-through (VST) extended reality (XR).

In a first embodiment, an apparatus configured to be worn on a user's head includes at least one imaging sensor configured to capture first image frames having a first dynamic range. The apparatus also includes at least one processing device configured, for each of at least one of the first image frames, to (i) generate a tone mapping filter configured to provide noise reduction and edge preservation while being guided by image and feature information and (ii) apply the tone mapping filter to the first image frame in order to transform the first image frame into a second image frame having a second dynamic range smaller than the first dynamic range. The tone mapping filter is configured to be applied to a luminance channel associated with the first image frame and not chrominance channels associated with the first image frame. The apparatus further includes at least one display configured to present one or more rendered images or videos to the user based on the second image frame for each of at least one of the first image frames.

In a second embodiment, a method includes obtaining first image frames having a first dynamic range captured using at least one imaging sensor of a VST XR device. The method also includes, for each of at least one of the first image frames, (i) generating a tone mapping filter configured to provide noise reduction and edge preservation while being guided by image and feature information and (ii) applying the tone mapping filter to the first image frame in order to transform the first image frame into a second image frame having a second dynamic range smaller than the first dynamic range. The tone mapping filter is applied to a luminance channel associated with the first image frame and not chrominance channels associated with the first image frame. The method further includes presenting one or more rendered images or videos based on the second image frame for each of at least one of the first image frames using at least one display of the VST XR device.

In a third embodiment, a non-transitory machine readable medium contains instructions that when executed cause at least one processor of a VST XR device to obtain first image frames having a first dynamic range captured using at least one imaging sensor of the VST XR device. The non-transitory machine readable medium also contains instructions that when executed cause the at least one processor, for each of at least one of the first image frames, to (i) generate a tone mapping filter configured to provide noise reduction and edge preservation while being guided by image and feature information and (ii) apply the tone mapping filter to the first image frame in order to transform the first image frame into a second image frame having a second dynamic range smaller than the first dynamic range. The tone mapping filter is configured to be applied to a luminance channel associated with the first image frame and not chrominance channels associated with the first image frame. The non-transitory machine readable medium further contains instructions that when executed cause the at least one processor to initiate display of one or more rendered images or videos based on the second image frame for each of at least one of the first image frames using at least one display of the VST XR device.

Any one or any combination of the following features may be used with the first, second, or third embodiment. The image and feature information may include, for each of the at least one of the first image frames, at least one of: image intensity information associated with the first image frame, image features associated with the first image frame, depth information associated with the first image frame, depth features associated with the first image frame, or spatial information associated with the first image frame. The tone mapping filter may be configured to perform contrast reduction filtering using different weights, and the different weights may be associated with two or more of: the image intensity information, the image features, the depth information, the depth features, or the spatial information. For each of the at least one of the first image frames, a logarithm transformation and color conversion of the first image frame may be performed before generation of the tone mapping filter in order to convert the first image frame from a first image format that lacks luminance data to a second image format that includes luminance data. For each of the at least one of the first image frames, the first image frame may be mapped to a rendering mesh before performance of the logarithm transformation and color conversion, and the rendering mesh may have a resolution that is lower than a resolution of the first image frame. For each of the at least one of the first image frames, a combined look-up table that combines spatial information and weighting may be used in order to map between source pixels of the first image frame and target pixels of the corresponding second image frame, and the target pixels may be located on the rendering mesh. Values of the target pixels located on the rendering mesh may be propagated to other pixels of the corresponding second image frame not located on the rendering mesh. For each of the at least one of the first image frames, a passthrough transformation, display lens correction, and chromatic aberration correction may be applied to the second image frame in order to generate a corrected second image frame, and the corrected second image frame may be rendered.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which:

FIG. 1 illustrates an example network configuration including an electronic device in accordance with this disclosure;

FIG. 2 illustrates an example process for local tone mapping with noise reduction and edge preservation for video see-through (VST) extended reality (XR) in accordance with this disclosure;

FIG. 3 illustrates an example architecture for local tone mapping with noise reduction and edge preservation for VST XR in accordance with this disclosure; and

FIG. 4 illustrates an example method for local tone mapping with noise reduction and edge preservation for VST XR in accordance with this disclosure.

### DETAILED DESCRIPTION

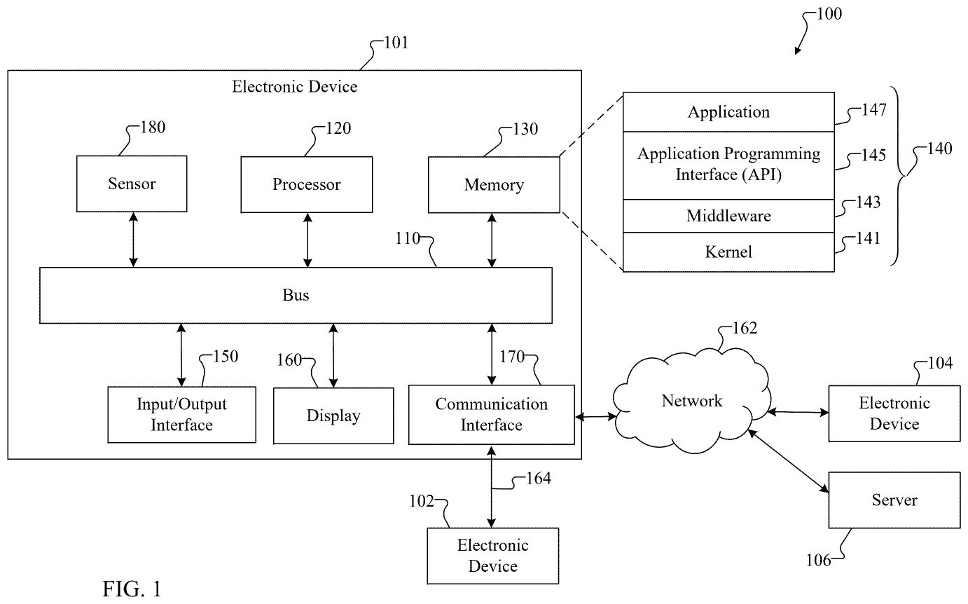

FIGS. 1 through 4, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes.

Optical see-through (OST) XR systems refer to XR systems in which users directly view real-world scenes through head-mounted devices (HMDs). Unfortunately, OST XR systems face many challenges that can limit their adoption. Some of these challenges include limited fields of view, limited usage spaces (such as indoor-only usage), failure to display fully-opaque black objects, and usage of complicated optical pipelines that may require projectors, waveguides, and other optical elements. In contrast to OST XR systems, video sec-through (VST) XR systems (also called “passthrough” XR systems) present users with generated video sequences of real-world scenes. VST XR systems can be built using virtual reality (VR) technologies and can have various advantages over OST XR systems. For example, VST XR systems can provide wider fields of view and can provide improved contextual augmented reality.

A VST XR device often includes one or more imaging sensors (also called “see-through cameras”) that capture high-resolution image frames of a user's surrounding environment. These image frames are processed in an image processing pipeline in order to generate final rendered views of the user's surrounding environment. Unfortunately, VST XR devices can suffer from various problems. One problem is that the captured image frames often represent high dynamic range (HDR) image frames, while displays used in VST XR devices often present standard dynamic range (SDR) image frames (sometimes also referred to as low dynamic range (LDR) image frames). HDR image frames often contain areas having much higher contrast than other areas, which can make it difficult to see details throughout the entire image frames. Prior approaches often convert HDR image frames into SDR image frames by reducing the contrast of the HDR image frames. However, this process can result in the smoothing of object edges and other features captured in the HDR image frames, which introduces blurring artifacts or other undesirable artifacts.

This disclosure provides various techniques supporting local tone mapping with noise reduction and edge preservation for VST XR. As described in more detail below, first image frames having a first dynamic range can be obtained using at least one imaging sensor of a VST XR device. For each of at least one of the first image frames, (i) a tone mapping filter configured to provide noise reduction and edge preservation while being guided by image and feature information can be generated and (ii) the tone mapping filter can be applied to the first image frame in order to transform the first image frame into a second image frame having a second dynamic range smaller than the first dynamic range. The tone mapping filter can be applied to a luminance channel associated with the first image frame and not chrominance channels associated with the first image frame. One or more rendered images or videos based on the second image frame for each of at least one of the first image frames can be presented using at least one display of the VST XR device.

In this way, the disclosed techniques provide for improved conversion of HDR image frames into SDR image frames or otherwise between image frames having different dynamic ranges. Among other things, each local tone mapping filter here can smooth high contrast areas while preserving object edges and other image features during filtering, which reduces or avoids the introduction of blurring artifacts or other artifacts. This conversion may be achieved using information from the image frames themselves, such as each image frame's intensity information, image features, depth information/features, and/or spatial information. Also, each local tone mapping filter can be applied to luminance channel data and not chrominance channel data of each image frame, which can help to improve performance and/or reduce the computational resources needed for the conversion. In some cases, precise mapping values for pixels on a rendering mesh for each second image frame can be determined using local tone mapping, and these pixels can be propagated across the grid to neighboring areas for each second image frame. Moreover, in some cases, look-up tables combining spatial information and rapid weighting functions may be used during guidance of each local tone mapping filter. In addition, in some cases, the conversion of some image frames may be skipped, such as when the user's head pose remains substantially unchanged or varies gradually. Any or all of these can help to accelerate the conversion process and/or reduce the computational resources needed for the conversion.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, and a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described below, the processor 120 may perform one or more functions related to local tone mapping with noise reduction and edge preservation for VST XR.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications that, among other things, perform local tone mapping with noise reduction and edge preservation for VST XR. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, the sensor(s) 180 can include one or more cameras or other imaging sensors, which may be used to capture images of scenes. The sensor(s) 180 can also include one or more buttons for touch input, one or more microphones, a depth sensor, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. Moreover, the sensor(s) 180 can include one or more position sensors, such as an inertial measurement unit that can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the electronic device 101 can be a wearable device or an electronic device-mountable wearable device (such as an HMD). For example, the electronic device 101 may represent an XR wearable device, such as a headset or smart eyeglasses. In other embodiments, the first external electronic device 102 or the second external electronic device 104 can be a wearable device or an electronic device-mountable wearable device (such as an HMD). In those other embodiments, when the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may perform one or more functions related to local tone mapping with noise reduction and edge preservation for VST XR.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

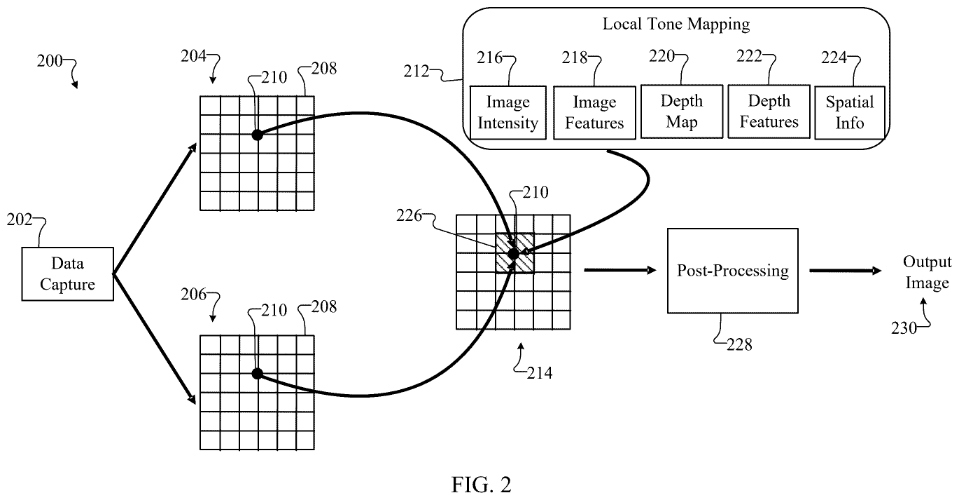

FIG. 2 illustrates an example process 200 for local tone mapping with noise reduction and edge preservation for VST XR in accordance with this disclosure. For case of explanation, the process 200 of FIG. 2 is described as being performed using the electronic device 101 in the network configuration 100 of FIG. 1. However, the process 200 may be performed using any other suitable device(s) and in any other suitable system(s).

As shown in FIG. 2, a data capture function 202 is used to obtain at least one image frame 204. For example, the data capture function 202 can involve obtaining see-through image frames 204 captured using one or more see-through cameras or other imaging sensors 180 of a VST XR device. In some cases, the data capture function 202 may be used to obtain image frames 204 at a desired frame rate, such as 30, 60, 90, or 120 frames per second. The data capture function 202 may also be used to obtain image frames 204 from any suitable number of imaging sensors 180, such as from left and right see-through cameras. Each image frame 204 can have any suitable size, shape, and resolution and include image data in any suitable domain. As particular examples, each image frame 204 may include RGB image data, YUV image data, or Bayer or other raw image data. At least some of the image frames 204 can represent HDR image frames or other image frames having a higher dynamic range. In some cases, at least some of the image frames 204 may include ten-bit image data.

The data capture function 202 can also optionally be used to obtain at least one depth map 206 or other depth data related to the image frames 204 being captured. For instance, at least one depth sensor 180 used in or with the VST XR device may capture depth data within the scene being imaged using the see-through camera(s). Any suitable type(s) of depth sensor(s) 180 may be used, such as light detection and ranging (LIDAR) or time-of-flight (ToF) depth sensors. In some cases, the depth data that is obtained can have a resolution that is less than (and possibly significantly less than) the resolution of the captured image frames 204. For example, the depth data may have a resolution that is equal to or less than half a resolution of each of the captured image frames 204. As a particular example, the captured image frames 204 may have a 3K or 4K resolution, and the depth maps 206 may have a resolution of 320 depth values by 320 depth values or 480 depth values by 480 depth values. Among other things, the depth values can be used to differentiate between pixels associated with objects and object edges more in the foregrounds of scenes and pixels associated with backgrounds of scenes.

Each image frame 204 may optionally be mapped onto a rendering mesh 208, and each depth map 206 may optionally be mapped onto the rendering mesh 208. Each rendering mesh 208 represents a grid or other mesh pattern in which various lines meet at various vertices. In some embodiments, each rendering mesh 208 can vary depending on the scene being imaged, such as when each rendering mesh 208 defines the contours of three-dimensional (3D) content within the associated image frame 204. Rendering meshes 208 can be generated in various ways, and the rendering meshes 208 can be applied to the image frames 204 and optionally to the depth maps 206 in order to identify which pixel data or depth data lies on the vertices 210 of the rendering meshes 208. Note, however, that the use of the rendering meshes is optional.

A local tone mapping function 212 can be used to process each image frame 204 and optionally its associated depth map 206 in order to generate a tone-mapped image frame 214 for each image frame 204. Each tone-mapped image frame 214 represents a version of the corresponding image frame 204 with a reduced dynamic range. For example, each tone-mapped image frame 214 can represent an SDR image frame or other image frame having a lower dynamic range, such as a dynamic range suitable for presentation on the display(s) 160. In some cases, at least some of the tone-mapped image frames 214 may include eight-bit image data. Each tone-mapped image frame 214 may also include less noise than the corresponding image frame 204.

The local tone mapping function 212 can apply smoothing to compress the dynamic range of the image frames 204 and produce the tone-mapped image frames 214, which can be accomplished while keeping much or all of the image sharpness in the image frames 204. As described in more detail below, the local tone mapping function 212 can use information from or associated with the image frames 204 in order to compress the dynamic range of the image frames 204, so the local tone mapping function 212 may be referred to as being “guided.” Moreover, the local tone mapping function 212 can help to remove at least some of the noise contained in the image frames 204, so the local tone mapping function 212 may be referred to as providing “noise reduction.” Further, the local tone mapping function 212 can be used to maintain textures, edges, or other image features contained in the image frames 204, which is why the local tone mapping function 212 may be referred to as providing “edge preservation.” In addition, the local tone mapping function 212 can apply tone mapping based on neighborhoods of pixels within the image frames 204 (rather than all pixels within the image frames 204), which is why the local tone mapping function 212 may be referred to as providing “local” tone mapping.

As shown here, the local tone mapping function 212 may use various types of information when performing tone mapping. In this particular example, the local tone mapping function 212 may use image intensity information 216, which represents the intensities of various pixels or other portions of each image frame 204. The local tone mapping function 212 may use image features 218, which represent higher-frequency components of each image frame 204. The local tone mapping function 212 may use depth maps 220, which identify depths within each image frame 204. Note that the depth maps 220 may or may not represent the depth maps 206. In some cases, for instance, the depth maps 206 may be combined with depths determined in other ways (such as depths determined using disparities in stereo image pairs) in order to increase the resolution of the depth data and produce dense depth maps 220, which is often referred to as depth densification. The local tone mapping function 212 may use depth features 222, which represent higher-frequency components of each depth map 206 or 220 or other depth data. The local tone mapping function 212 may use spatial information 224, which refers to information that identifies spatial characteristics of the image frames 204 (such as based on the resolution of the image frames 204). Note that while all five types of information 216-224 are shown here, the local tone mapping function 212 may use one, any subcombination, or all of the various types of information 216-224 when performing local tone mapping depending on the implementation.

In some embodiments, for each image frame 204, the local tone mapping function 212 can perform tone mapping for pixels located on the vertices 210 of the rendering mesh 208 for that image frame 204. For example, for each specified pixel located on a vertex 210 of the rendering mesh 208, the local tone mapping function 212 may generate a weighted average of pixel values within a neighborhood 226 around that pixel. For each specified pixel not located on a vertex 210 of the rendering mesh 208, the local tone mapping function 212 can determine a pixel value for that specified pixel using the pixel values of the pixels on the vertices 210 around the specified pixel, such as by interpolating the values of the pixels on the vertices 210 within the neighborhood 226 around the specified pixel or otherwise suitably close to the specified pixel. This can be referred to as “propagating” the pixel values located on the vertices 210 to pixel values not located on the vertices 210. Thus, the local tone mapping function 212 may identify pixel values for the pixels located on the vertices 210, and the local tone mapping function 212 may propagate those pixel values to other pixels in order to generate pixel values for the pixels not located on the vertices 210. This results in the generation of each tone-mapped image frame 214, which has a lower dynamic range than its corresponding image frame 204 while preserving edges contained in the corresponding image frame 204. As can be seen here, the rendering meshes 208 can be beneficial in that they can help to save computational resources and improve performance (compared to performing tone mapping for all image data at all pixels of the image frames 204), although the use of the rendering meshes 208 is optional as noted above.

In some embodiments, the local tone mapping function 212 is implemented using a filter. The filter can apply various weights to various data associated with a neighborhood of pixels around each specified pixel (each of which might be on a vertex 210 of a rendering mesh 208) in order to generate a filtered pixel value for that specified pixel. As a particular example, each filtered pixel value generated using the filter may be expressed as follows.

$${Pixel}_{update} = {Filter}_{neighborhood} ( Image Intensity , Image Features , Depths , Depth Features , Spatial Info , Pixels )$$

Here, Pixel_{update} represents a filtered version of a specified pixel, and Filter_{Neighborhood} represents a filter applied to various data from the associated neighborhood 226 around that specified pixel. Also, Pixels represents the pixels in the associated neighborhood 226 around the specified pixel. The various data used here includes the various types of information 216-224 shown in FIG. 2, which are represented as Image Intensity, Image Features, Depths, Depth Features, and Spatial Info. Note, however, that not all of these types of information 216-224 may be available or used, and/or additional information might be considered here.

Note that the local tone mapping function 212 here can be applied to pixels in one image data channel of each image frame 204. For example, the local tone mapping function 212 can be applied to the luminance channel of each image frame 204, and the local tone mapping function 212 need not be applied to chrominance channels of each image frame 204. This allows the local tone mapping function 212 to transform the brightness channel of each image frame 204 in order to adjust the contrast within the image frame 204. As noted above, this can help to speed up the conversion and/or the reduce computational loads. This results in improved performance, which can be very important for applications like VST XR in order to provide improved user experiences.

Each tone-mapped image frame 214 may be provided to at least one post-processing function 228, which can perform one or more additional operations involving the tone-mapped image frame 214 in order to generate an output image 230. For example, the at least one post-processing function 228 may apply a passthrough transformation, apply display lens correction, and apply chromatic aberration correction to each tone-mapped image frame 214. In some cases, the passthrough transformation (which may represent a static transformation) can be applied to the tone-mapped image frames 214 in order to compensate for things like registration and parallax errors, which may be caused by factors like differences between the positions of the see-through cameras and a user's eyes. The display lens correction and the chromatic aberration correction can be used to compensate for distortions created in displayed images, such as geometric distortions and chromatic aberrations created by display lenses (which are lenses positioned between the user's eyes and one or more display panels forming the display(s) 160). The at least one post-processing function 228 may also or alternatively be used to enhance various high-frequency features or other features in each tone-mapped image frame 214 (such as features of objects or text) to improve the clarity of each resulting output image 230. Among other things, this may help to improve the readability of text captured in the image frames 204. The output images 230 can be used in any suitable manner, such as by rendering the output images 230 for presentation on the display(s) 160 of the VST XR device. The at least one post-processing function 228 may use any suitable technique(s) for enhancing or otherwise post-processing images.

Although FIG. 2 illustrates one example of a process 200 for local tone mapping with noise reduction and edge preservation for VST XR, various changes may be made to FIG. 2. For example, various components or functions in FIG. 2 may be combined, further subdivided, replicated, omitted, or rearranged and additional components or functions may be added according to particular needs. Also, each rendering mesh 208 may include any suitable number of lines and any suitable number of vertices, or use of the rendering meshes 208 may be omitted.

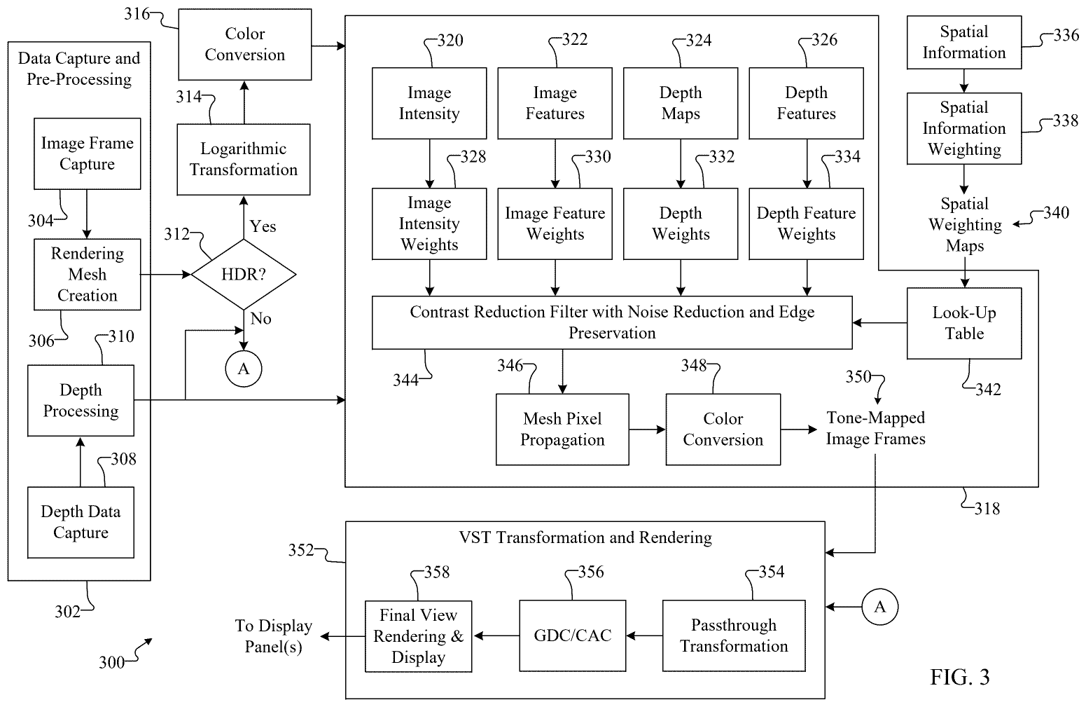

FIG. 3 illustrates an example architecture 300 for local tone mapping with noise reduction and edge preservation for VST XR in accordance with this disclosure. For case of explanation, the architecture 300 of FIG. 3 is described as being implemented using the electronic device 101 in the network configuration 100 of FIG. 1, such as to implement the process 200 shown in FIG. 2. However, the architecture 300 may be implemented using any other suitable device(s) and in any other suitable system(s), and the architecture 300 may be used to implement any other suitable process designed in accordance with this disclosure.

As shown in FIG. 3, the architecture 300 includes a data capture and pre-processing operation 302, which generally operates to obtain image frames 204 and optionally other data (such as depth maps 206) and pre-process the obtained data. In some embodiments, the data capture and pre-processing operation 302 may implement the data capture function 202 described above. In this example, the data capture and pre-processing operation 302 includes an image frame capture function 304, which generally operates to obtain image frames of a scene. For example, the image frame capture function 304 can be used to obtain see-through image frames 204, such as from one or more see-through cameras or other imaging sensors 180 of a VST XR device.

The captured image frames 204 are provided to a rendering mesh creation function 306, which generally operates to identify a rendering mesh 208 for each image frame 204. In some embodiments, the rendering mesh 208 for an image frame 204 can be based on contours of 3D content within each image frame 204. In some cases, the rendering mesh 208 for one image frame 204 in a sequence can be based on the rendering mesh 208 for a prior image frame 204 in the sequence. Thus, for instance, each rendering mesh 208 can include lines and vertices 210, and certain vertices 210 may move from one image frame 204 to the next depending on changes within the scene and changes of the position of the VST XR device. The rendering mesh creation function 306 can use any suitable technique to identify rendering meshes 208 for image frames 204. The rendering mesh creation function 306 can also map each rendering mesh 208 onto the associated image frame 204. For instance, the rendering mesh creation function 306 can determine which pixels of each image frame 204 fall on the vertices 210 of the associated rendering meshes 208.

The data capture and pre-processing operation 302 also optionally includes a depth data capture function 308, which generally operates to obtain depth-related information associated with depths within the scene captured in the image frames 204. For example, the depth data capture function 308 can be used to obtain the depth maps 206, such as by using one or more depth sensors 180 of the VST XR device. A depth processing function 310 generally operates to pre-process the obtained depth data, such as by mapping each depth map 206 or other depth data onto the associated rendering mesh 208. For instance, the depth processing function 310 can determine which depth values of each depth map 206 fall on the vertices 210 of the associated rendering mesh 208. The depth processing function 310 may also perform functions like interpolation in order to increase the density of the depth values in the depth maps or other depth data.

A determination function 312 determines whether each image frame 204 represents an HDR image or other image having a higher-than-desired dynamic range. In some cases, an image frame 204 may not require local tone mapping, such as when the image frame 204 already has an acceptably-low dynamic range. If it is determined that an image frame 204 does not need local tone mapping, the image frame 204 may skip the local tone mapping and proceed straight to transformation and rendering. Assuming local tone mapping is to be performed, the image frame 204 is processed using a logarithmic transformation function 314 and a color conversion function 316.

The logarithmic transformation function 314 generally operates to bound irradiance data of each image frame 204 to a specified range of values. For example, the logarithmic transformation function 314 may bound the irradiance data of each image frame 204 to a range of values between zero and one (inclusive). Effectively, the logarithmic transformation function 314 can reduce the number of bits in the image data of the image frames 204. The color conversion function 316 generally operates to convert image data of each image frame 204 (or image data as converted by the logarithmic transformation function 314) between image domains. More specifically, the color conversion function 316 can convert image data from one image format that lacks luminance data to another image format that includes luminance data. For instance, the color conversion function 316 may convert RGB image data or other data that lacks a luminance channel into Hue, Saturation, and Value (HSV) image data or other data that includes a luminance channel. In some cases, the color conversion function 316 may implement a fast color conversion process. This conversion allows tone mapping to be applied to the luminance (brightness) channel of the image frame 204.

A local tone mapping operation 318 generally operates to process the obtained image frames 204 (or pre-processed versions thereof) in order to generate SDR images or other images having a desired lower dynamic range. In some embodiments, the local tone mapping operation 318 may implement the local tone mapping function 212 described above. As shown in this example, the local tone mapping operation 318 obtains or has access to one or more types of information from or related to the image frames 204 being processed. For example, the local tone mapping operation 318 may obtain or have access to image intensity information 320, image features 322, depth maps 324, and depth features 326 (or any one or combination thereof). These types of information 320-326 may be the same as or similar to the corresponding types of information 216-222 shown in FIG. 2 and described above. Weights 328-334 can be respectively applied to the various types of information 320-326 that are available and used with each image frame 204.

The local tone mapping operation 318 can also or alternatively receive input based on spatial information 336, which may be the same as or similar to the spatial information 224 shown in FIG. 2 and described above. In some cases, the spatial information 336 may be the same for all image frames 204 in a set being processed since the image frames 204 can have the same resolution. Based on the spatial information 336, a spatial information weighting function 338 can be applied to the spatial information 336 in order to generate weights 340 associated with the spatial information 336. In some cases, the weights 340 may take the form of a spatial weight map. Also, in some cases, the spatial information can be constant for image frames 204 having the same resolution. It is therefore possible to precompute the spatial weights 340 and, when image frames of a specified resolution are obtained, load the correct precomputed spatial weights 340 into a look-up table 342. This can allow the correct spatial weights 340 to be applied very quickly without requiring re-computation of the spatial weights.

The local tone mapping operation 318 applies one or more tone mapping filters 344 to one or more image frames 204 in order to reduce the contrast (and therefore the dynamic range) of the image frame(s) 204. For example, the local tone mapping operation 318 may generate a tone mapping filter 344 for each of at least some of the image frames 204. For each image frame 204, the local tone mapping operation 318 can apply the corresponding tone mapping filter 344 in order to lower that image frame's dynamic range. Each tone mapping filter 344 here can represent a guided filter, such as when the tone mapping filter 344 is guided by the associated image frame 204 being filtered.

The determination of which weight or weights 328-334, 340 are used here can depend on which type or types of information 320-326, 336 are available. Thus, if one or a subset of the types of information 320-326, 336 are available, one or a subset of the weights 328-334, 340 may be used. In some cases, the weight or weights 328-334, 340 that are used can be applied by the tone mapping filter 344 to information associated with pixels within the neighborhood 226 around each pixel falling on a vertex 210 of the associated rendering mesh 208. In other cases, the weight or weights 328-334, 340 that are used can be applied by the tone mapping filter 344 to information associated with all pixels.

As a particular example, multiple weights 328-334, 340 may be used to generate a weighted average of the pixel values within the neighborhood 226 around each pixel falling on a vertex 210 of the associated rendering mesh 208. The weighted average or other results generated using the tone mapping filter 344 represent image data with reduced contrast and often reduced noise. Because the tone mapping filter 344 is guided by information like image intensities, image features, depths, depth features, and/or spatial information, image edges and other image features can be preserved more effectively in the resulting filtered image frames. Based on this guidance, the local tone mapping operation 318 can efficiently compress the HDR or other higher dynamic range of the image frames 204 and reduce the noise contained in the image frames 204 while more effectively preserving edges within the image frames 204.

Each resulting image frame generated using the tone mapping filter 344 can include filtered image data, possibly only on the vertices 210 of the associated rendering mesh 208. For each image frame 204, a mesh pixel propagation function 346 generally operates to propagate pixel values for the pixels located at the vertices 210 of the rendering mesh 208 to other pixels not located at the vertices 210 of the rendering mesh 208. In some cases, for each specified pixel not located at a vertex 210 of the associated rendering mesh 208, the mesh pixel propagation function 346 may perform interpolation or other combination of pixel values for pixels that are located within the neighborhood 226 around the specified pixel or that are otherwise suitably close to the specified pixel.

Another color conversion function 348 generally operates to convert tone-mapped image data between image domains. More specifically, the color conversion function 348 can convert image data from one image format that includes luminance data to another image format that lacks luminance data. For instance, the color conversion function 348 may convert HSV image data or other data that includes a luminance channel into RGB image data or other data that lacks a luminance channel. In some cases, the color conversion function 348 may implement a fast color conversion process. This conversion can represent an inverse operation compared to the conversion performed by the color conversion function 316 and may return the image data to its original domain in some cases.

The local tone mapping operation 318 here generally operates to produce tone-mapped image frames 350, which can correspond to the tone-mapped image frames 214 of FIG. 2. The resulting tone-mapped image frames 350 are provided to a VST transformation and rendering operation 352, which generally operates to create final views of the scene captured in the image frames 204 and render the final views for presentation to a user of a VST XR device. The VST transformation and rendering operation 352 can perform similar operations for image frames 204 determined to not have a higher-than-desired dynamic range by the determination function 312.

In this example, the VST transformation and rendering operation 352 includes a passthrough transformation function 354, which generally operates to apply a passthrough transformation to the tone-mapped image frames 350. As noted above, a passthrough transformation can be applied to tone-mapped image frames 350 in order to compensate for things like registration and parallax errors, which may be caused by factors like differences between the positions of the see-through cameras and a user's eyes. For instance, the passthrough transformation function 354 may apply a rotation and/or a translation to each tone-mapped image frame 350 in order to compensate for these types of issues and give the appearance that images captured at the location(s) of the see-through camera(s) were actually captured at the locations of the user's eyes. Often times, the rotation and/or translation can be derived mathematically based on the position and angle of each imaging sensor 180 and the expected or actual positions of the user's eyes. In some cases, the passthrough transformation function is static (since these positions and angles will not change), allowing the passthrough transformation to be loaded and applied quickly.

A geometric distortion correction (GDC)/chromatic aberration correction (CAC) function 356 can modify the tone-mapped image frames 350 to account for distortions created in displayed images. For instance, in many VST XR devices, rendered images are presented on one or more display panels (such as one or more displays 160), and rendered images are often viewed by the user through left and right display lenses positioned between the user's eyes and the display panel(s). However, the display lenses may create geometric distortions when displayed images are viewed, and the display lenses may create chromatic aberrations when light passes through the display lenses. The GDC/CAC function 356 can make adjustments to the tone-mapped image frames 350 so that the resulting images pre-compensate for the expected geometric distortions and chromatic aberrations. Thus, the GDC/CAC function 356 may determine how images should be pre-distorted to compensate for the subsequent geometric distortions and chromatic aberrations created when the images are displayed and viewed through the display lenses. In some cases, the GDC/CAC function 356 may operate based on a display lens GDC and CAC model, which can mathematically represent the geometric distortions and chromatic aberrations created by the display lenses.

A final view rendering and display function 358 can process the corrected image frames and perform any additional refinements or modifications needed or desired, and the resulting images can represent the final views of the scene. For example, a 3D-to-2D warping can be used to warp the final views of the scene into 2D images. The final view rendering and display function 358 can also present the rendered images to the user. For instance, the final view rendering and display function 358 can render the images into a form suitable for transmission to at least one display 160 and can initiate display of the rendered images, such as by providing the rendered images to one or more displays 160.

In this way, the architecture 300 can support a number of useful features or functions. For example, the architecture 300 can create a tone mapping filter 344 for an HDR or other higher dynamic range image frame in order to generate an SDR or other lower dynamic range image frame while reducing noise and preserving edges. This can be accomplished since the tone mapping filter 344 can be guided by the information from the original image frame (like image intensities, image features, a depth map, depth features, or spatial information). A rendering mesh may be used to allow tone mapping for some pixels (those on vertices of the rendering mesh), and the resulting pixel values can be propagated to other pixels (those not on vertices of the rendering mesh). In some cases, this can be done for a single image data channel of the HDR or other higher dynamic range image frame. As a result, this can increase performance and provide computational resource savings. In addition, the use of the look-up table 342 can support the combination of spatial information and fast weighting functions, which again can increase performance and provide computational resource savings.

Note that while the local tone mapping operation 318 is described above as generating a tone mapping filter 344 for each image frame 204, this is not necessarily required. For example, it is possible to re-use the same tone mapping filter 344 for multiple image frames 204. As particular examples, when the user's head is substantially stationary, the same tone mapping filter 344 may be used for a number of image frames 204. When the user's head pose is changing slowly over time, the local tone mapping operation 318 can update the tone mapping filter 344 less often than once per image frame 204.

This type of functionality may find use in a number of applications. For example, this functionality may be used to create images having lower dynamic range from image frames having higher dynamic range, such as for generation and presentation of SDR images on a normal-range display. This can be achieved by compressing the larger dynamic range of the image frames without blurring image features. This functionality may be used to provide color distortion correction for HDR images frames or other image frames having higher dynamic range. For instance, when displaying HDR images directly on a normal-range display, colors and contrasts can be distorted. The described functionality above can correct these distortions with local tone mapping so that the generated images can be displayed on the display with little or no distortion. This functionality may be used to provide noise reduction without introducing edge blurring. This is because the described techniques can smooth dynamic range changes that occur suddenly and can filter noise using local filtering. During such noise filtering, information like image intensity information, depth information, and feature information can be used for guiding the operations in order to reduce or avoid smoothing edge information in the images.

The following now describes how certain operations within the architecture 300 may be designed or performed. Operation of the tone mapping filter 344 can be denoted as [symbol] (⋅), and the tone mapping filter 344 can be used to determine pixel values guided by the various types of image-related information 320-326, 336. In some cases, the output of the tone mapping filter 344 may be expressed as follows.

$${I}_{output} ( p ) = 𝒯 ( Image Intensity , Image Features , Depths , Depth Features , Spatial Info , {I}_{input} ( p ) )$$

Here, Iₒᵤₜₚᵤₜ(p) represents an output pixel value after local tone mapping, and Iᵢₙₚᵤₜ(p) represents an input pixel value. A guiding function may be denoted as [symbol] (⋅), and the guiding function can control how the various types of information 320-326, 336 are used by the tone mapping filter 344. In some cases, the guiding function may be expressed as follows.

$$𝒢 ( p ) = 𝒢 ( Image Intensity , Image Features , Depths , Depth Features , Spatial Info )$$

Based on this, the output of the tone mapping filter 344 may be rewritten as follows.

$${I}_{output} ( p ) = 𝒯 ( 𝒢 ( p ) , {I}_{input} ( p ) )$$

In some cases, the guiding function [symbol] (⋅) can be constructed using weights 328-334, 340 based on the various types of information 320-326, 336 in order to leverage the effects of the different types of information 320-326, 336. As described above, the weights 328-334, 340 can be created from image intensities, image features, depth maps, depth features, and/or spatial information for use by the tone mapping filter 344.

In some embodiments, image intensity weights 328 wᵢᵢ (p, pₙₙ) can be created from image intensities for an image I at each pixel p using a Gaussian distribution with a normalized intensity difference between pixel p and its neighborhood pixels pₙₙ and the mean and standard deviation associated with the pixel values. Image feature weights 330 w_{if} (p, pₙₙ) can be created from image feature information I_{f} for an image I at each pixel p using a Gaussian distribution with a normalized image feature difference between pixel p and its neighborhood pixels pₙₙ and the mean and standard deviation associated with the image features. Depth weights 332 w_{dm} (p, pₙₙ) can be created from depth map information I_{d} for an image I at each pixel p using a Gaussian distribution with a normalized depth difference between pixel p and its neighborhood pixels pₙₙ and the mean and standard deviation associated with the depth map information. Depth feature weights 334 w_{df} (p, pₙₙ) can be created from depth feature information I_{df} for an image I at each pixel p using a Gaussian distribution with a normalized depth feature difference between pixel p and its neighborhood pixels pₙₙ and the mean and standard deviation associated with the depth feature information. Spatial weights 340 wₛᵢ(p, pₙₙ) can be created from spatial information for an image I at each pixel p using a Gaussian distribution with a normalized spatial difference between pixel p and its neighborhood pixels pₙₙ and the mean and standard deviation associated with the depth feature information. As noted above, if the spatial information stays the same for all image frames 204 with the same resolution, the spatial weights 340 can be precomputed and saved (such as in the memory 130 of a VST XR device). The appropriate spatial weights 340 for a given image resolution can subsequently be loaded into the look-up table 342 for faster use. In some cases, the contents of the look-up table 342 may be defined as follows.

$${Map}_{{w}_{si}} ( p ( x , y ) ) = {w}_{si} ( p ( x , y ) )$$

Based on these weights 328-334, 340, the output of the tone mapping filter 344 may now be expressed as follows.

$${I}_{output} ( p ) = \frac{1}{{\sum }_{{p}_{nn} ∈ N ( p )} w ( {p}_{nn} )} {\sum }_{{p}_{nn} ∈ N ( p )} w ( {p}_{nn} ) {I}_{input} ( {p}_{nn} )$$

Here, Iᵢₙₚᵤₜ(pₙₙ) represents the value of each neighborhood pixel pₙₙ. Also, w(pₙₙ) represents a combined weight, which in some cases could be expressed as follows.

$$w ( {p}_{nn} ) = {w}_{ii} ( {p}_{nn} ) {w}_{if} ( {p}_{nn} ) {w}_{dm} ( {p}_{nn} ) {w}_{df} ( {P}_{nn} ) {w}_{si} ( {P}_{nn} )$$

As noted above, a single type of information 320-326, 336 or a subset of the various types of information 320-326, 336 may be used, and the equations above may be adjusted to account for the weight(s) actually being used by the tone mapping filter 344. Thus, for instance, if depth data is not available, the output of the tone mapping filter 344 may be expressed as follows.

$${I}_{output} ( p ) = 𝒯 ( Image Intensity , Image Features , Spatial Info , {I}_{input} ( p ) )$$

In some embodiments, the various weights 328-334, 340 described above can be determined using a Gaussian distribution, which may be expressed as follows.

$$w ( d ) = G ( d , μ , σ )$$

However, other distributions may be used. For instance, a simplified Gaussian distribution may be used for faster computations. Other distributions may also be used as needed or desired, and different distributions may have different effects on local tone mapping.

Although FIG. 3 illustrates one example of an architecture 300 for local tone mapping with noise reduction and edge preservation for VST XR, various changes may be made to FIG. 3. For example, various components or functions in FIG. 3 may be combined, further subdivided, replicated, omitted, or rearranged and additional components or functions may be added according to particular needs.

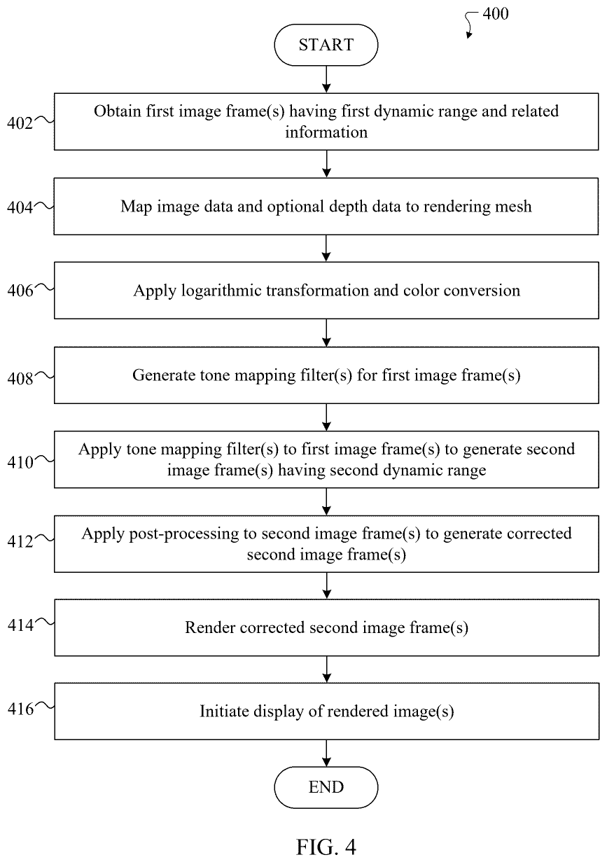

FIG. 4 illustrates an example method 400 for local tone mapping with noise reduction and edge preservation for VST XR in accordance with this disclosure. For case of explanation, the method 400 of FIG. 4 is described as being performed using the electronic device 101 in the network configuration 100 of FIG. 1, where the electronic device 101 can implement the architecture 300 of FIG. 3 and perform the process 200 of FIG. 2. However, the method 400 may be performed using any other suitable device(s) and in any other suitable system(s).

As shown in FIG. 4, one or more first image frames and related information are obtained at a VST XR device at step 402. This may include, for example, the processor 120 of the electronic device 101 obtaining one or more image frames 204 using one or more sec-through cameras or other imaging sensors 180 of the electronic device 101. This may also include the processor 120 of the electronic device 101 generating or otherwise obtaining one or more types of information 216-224, 320-326, 336 related to each image frame 204. Each first image frame may represent an HDR image frame or otherwise have a first dynamic range, which can be larger than desired.

Each first image frame may be mapped to a rendering mesh having various vertices at step 404. This may include, for example, the processor 120 of the electronic device 101 mapping the pixels of each image frame 204 to a corresponding rendering mesh 208 in order to identify which pixels of the image frame 204 are located at vertices 210 of the rendering mesh 208. A logarithm transformation and color conversion may be applied to each first image frame at step 406. This may include, for example, the processor 120 of the electronic device 101 performing the logarithmic transformation function 314 and the color conversion function 316 to generate image data for each image frame 204, where the image data includes values with fewer bits than the image frame 204 and where the image data includes a luminance channel.

A tone mapping filter is generated for each of at least some of the first image frames at step 408, and each tone mapping filter can be applied to one or more first image frames in order to generate one or more second image frames at step 410. This may include, for example, the processor 120 of the electronic device 101 performing the local tone mapping operation 318 to generate a tone mapping filter 344 for each of at least some of the image frames 204. In some cases, each tone mapping filter 344 can generate a weighted average for each pixel located on a vertex 210 of the rendering mesh 208, such as a weighted average of pixels in a neighborhood 226 around that pixel. Also, in some cases, each tone mapping filter 344 may be configured to provide local tone mapping using weights 328-334, 340 that are based on at least one of image intensity data associated with an image frame 204, an image feature map associated with an image frame 204, a depth map associated with an image frame 204, a depth feature map associated with an image frame 204, or spatial information (or a look-up table entry based on spatial information) associated with an image frame 204. This can result in the generation of one or more tone-mapped image frames 214, 350.

In some cases, the local tone mapping can be performed for the pixels of each image frame 204 located on the vertices 210 of the corresponding rendering mesh 208, which can help to reduce the number of computations performed. Note that the local tone mapping here can involve performance of the tone mapping using the tone mapping filter(s) 344 without losing edge information in the image frame(s) 204. Data of remaining pixels that are not located on the vertices 210 of the rendering mesh 208 for each image frame 204 can be determined based on the data of the pixels that are located on the vertices 210 of the rendering mesh 208, such as via interpolation or another function provided by the mesh pixel propagation function 346. Another color conversion function 348 may be performed here to convert the image data back into the original domain. Each second image frame may represent an SDR image frame or otherwise have a second dynamic range that is smaller than the first dynamic range.

Post-processing can be performed for each second image frame in order to generate a corrected second image frame at step 412. This may include, for example, the processor 120 of the electronic device 101 performing the at least one post-processing function 228, the passthrough transformation function 354, and/or the GDC/CAC function 356. This can result in the generation of one or more corrected versions of the tone-mapped image frame(s) 214, 350. Each resulting corrected second image frame is rendered at step 414, and display of each resulting rendered image is initiated at step 416. This may include, for example, the processor 120 of the electronic device 101 rendering the corrected tone-mapped image frame(s) and displaying the rendered image(s) on at least one display 160 of the electronic device 101.

Although FIG. 4 illustrates one example of a method 400 for local tone mapping with noise reduction and edge preservation for VST XR, various changes may be made to FIG. 4. For example, while shown as a series of steps, various steps in FIG. 4 may overlap, occur in parallel, occur in a different order, or occur any number of times (including zero times). Also, the method 400 may be repeated for any number of image frames 204, such as for each of multiple image frames 204 captured using left and right see-through cameras or other imaging sensors 180 of the VST XR device.

It should be noted that the functions shown in the figures or described above can be implemented in an electronic device 101, 102, 104, server 106, or other device(s) in any suitable manner. For example, in some embodiments, at least some of the functions shown in the figures or described above can be implemented or supported using one or more software applications or other software instructions that are executed by the processor 120 of the electronic device 101, 102, 104, server 106, or other device(s). In other embodiments, at least some of the functions shown in the figures or described above can be implemented or supported using dedicated hardware components. In general, the functions shown in the figures or described above can be performed using any suitable hardware or any suitable combination of hardware and software/firmware instructions. Also, the functions shown in the figures or described above can be performed by a single device or by multiple devices.

Although this disclosure has been described with example embodiments, various changes and modifications may be suggested to one skilled in the art. It is intended that this disclosure encompass such changes and modifications as fall within the scope of the appended claims.

What is claimed is:

1. An apparatus configured to be worn on a user's head, the apparatus comprising:
at least one imaging sensor configured to capture first image frames having a first dynamic range;
at least one processing device configured, for each of at least one of the first image frames, to:
generate a tone mapping filter configured to provide noise reduction and edge preservation while being guided by image and feature information; and
apply the tone mapping filter to the first image frame in order to transform the first image frame into a second image frame having a second dynamic range smaller than the first dynamic range, the tone mapping filter configured to be applied to a luminance channel associated with the first image frame and not chrominance channels associated with the first image frame; and
at least one display configured to present one or more rendered images or videos to the user based on the second image frame for each of at least one of the first image frames.

2. The apparatus of claim 1, wherein the image and feature information comprises, for each of the at least one of the first image frames, at least one of: image intensity information associated with the first image frame, image features associated with the first image frame, depth information associated with the first image frame, depth features associated with the first image frame, or spatial information associated with the first image frame.

3. The apparatus of claim 2, wherein the tone mapping filter is configured to perform contrast reduction filtering using different weights, the different weights associated with two or more of: the image intensity information, the image features, the depth information, the depth features, or the spatial information.

4. The apparatus of claim 1, wherein the at least one processing device is further configured, for each of the at least one of the first image frames, to perform a logarithm transformation and color conversion of the first image frame before generation of the tone mapping filter in order to convert the first image frame from a first image format that lacks luminance data to a second image format that includes luminance data.

5. The apparatus of claim 4, wherein:
the at least one processing device is further configured, for each of the at least one of the first image frames, to map the first image frame to a rendering mesh before performance of the logarithm transformation and color conversion; and
the rendering mesh has a resolution that is lower than a resolution of the first image frame.

6. The apparatus of claim 5, wherein the at least one processing device is further configured, for each of the at least one of the first image frames, to:
use a combined look-up table that combines spatial information and weighting in order to map between source pixels of the first image frame and target pixels of the corresponding second image frame, the target pixels located on the rendering mesh; and
propagate values of the target pixels located on the rendering mesh to other pixels of the corresponding second image frame not located on the rendering mesh.

7. The apparatus of claim 1, wherein the at least one processing device is further configured, for each of the at least one of the first image frames, to:
apply a passthrough transformation, display lens correction, and chromatic aberration correction to the second image frame in order to generate a corrected second image frame; and
render the corrected second image frame.

8. A method comprising:
obtaining first image frames having a first dynamic range captured using at least one imaging sensor of a video see-through (VST) extended reality (XR) device;
for each of at least one of the first image frames:
generating a tone mapping filter configured to provide noise reduction and edge preservation while being guided by image and feature information; and
applying the tone mapping filter to the first image frame in order to transform the first image frame into a second image frame having a second dynamic range smaller than the first dynamic range, the tone mapping filter applied to a luminance channel associated with the first image frame and not chrominance channels associated with the first image frame; and
presenting one or more rendered images or videos based on the second image frame for each of at least one of the first image frames using at least one display of the VST XR device.

9. The method of claim 8, wherein the image and feature information comprises, for each of the at least one of the first image frames, at least one of: image intensity information associated with the first image frame, image features associated with the first image frame, depth information associated with the first image frame, depth features associated with the first image frame, or spatial information associated with the first image frame.

10. The method of claim 9, wherein the tone mapping filter performs contrast reduction filtering using different weights, the different weights associated with two or more of: the image intensity information, the image features, the depth information, the depth features, or the spatial information.

11. The method of claim 8, further comprising:
for each of the at least one of the first image frames, performing a logarithm transformation and color conversion of the first image frame before generating the tone mapping filter in order to convert the first image frame from a first image format that lacks luminance data to a second image format that includes luminance data.

12. The method of claim 11, further comprising:
for each of the at least one of the first image frames, mapping the first image frame to a rendering mesh before performing the logarithm transformation and color conversion;
wherein the rendering mesh has a resolution that is lower than a resolution of the first image frame.

13. The method of claim 12, further comprising, for each of the at least one of the first image frames:
using a combined look-up table that combines spatial information and weighting in order to map between source pixels of the first image frame and target pixels of the corresponding second image frame, the target pixels located on the rendering mesh; and
propagating values of the target pixels located on the rendering mesh to other pixels of the corresponding second image frame not located on the rendering mesh.

14. The method of claim 8, further comprising, for each of the at least one of the first image frames:
applying a passthrough transformation, display lens correction, and chromatic aberration correction to the second image frame in order to generate a corrected second image frame; and
rendering the corrected second image frame.

15. A non-transitory machine readable medium containing instructions that when executed cause at least one processor of a video see-through (VST) extended reality (XR) device to:
obtain first image frames having a first dynamic range captured using at least one imaging sensor of the VST XR device;
for each of at least one of the first image frames:
generate a tone mapping filter configured to provide noise reduction and edge preservation while being guided by image and feature information; and
apply the tone mapping filter to the first image frame in order to transform the first image frame into a second image frame having a second dynamic range smaller than the first dynamic range, the tone mapping filter configured to be applied to a luminance channel associated with the first image frame and not chrominance channels associated with the first image frame; and
initiate display of one or more rendered images or videos based on the second image frame for each of at least one of the first image frames using at least one display of the VST XR device.

16. The non-transitory machine readable medium of claim 15, wherein the image and feature information comprises, for each of the at least one of the first image frames, at least one of: image intensity information associated with the first image frame, image features associated with the first image frame, depth information associated with the first image frame, depth features associated with the first image frame, or spatial information associated with the first image frame.

17. The non-transitory machine readable medium of claim 16, wherein the tone mapping filter is configured to perform contrast reduction filtering using different weights, the different weights associated with two or more of: the image intensity information, the image features, the depth information, the depth features, or the spatial information.

18. The non-transitory machine readable medium of claim 15, further containing instructions that when executed cause the at least one processor, for each of the at least one of the first image frames, to:
map the first image frame to a rendering mesh; and
perform a logarithm transformation and color conversion before generation of the tone mapping filter in order to convert the first image frame from a first image format that lacks luminance data to a second image format that includes luminance data;
wherein the rendering mesh has a resolution that is lower than a resolution of the first image frame.

19. The non-transitory machine readable medium of claim 18, further containing instructions that when executed cause the at least one processor, for each of the at least one of the first image frames, to:
use a combined look-up table that combines spatial information and weighting in order to map between source pixels of the first image frame and target pixels of the corresponding second image frame, the target pixels located on the rendering mesh; and
propagate values of the target pixels located on the rendering mesh to other pixels of the corresponding second image frame not located on the rendering mesh.

20. The non-transitory machine readable medium of claim 15, further containing instructions that when executed cause the at least one processor, for each of the at least one of the first image frames, to:
apply a passthrough transformation, display lens correction, and chromatic aberration correction to the second image frame in order to generate a corrected second image frame; and
render the corrected second image frame.
